(19) United States
(12) Patent Application Publication
(10) Pub. No.: US 2016/0203780 A1
(43) Pub. Date: Jul. 14, 2016

(54) LIQUID CRYSTAL DISPLAY DEVICE

(71) Applicant: SHARP KABUSHIKI KAISHA, Osaka (JP)

(72) Inventor: Yuichi KITA, Osaka-shi (JP)

(21) Appl. No.: 14/912,638

(22) PCT Filed: Aug. 11, 2014
(86) PCT No.: PCT/JP2014/071239

§ 371 Date: Feb. 18, 2016

(30) Foreign Application Priority Data
Aug. 23, 2013 (JP) 2013-173146

(51) Int. Cl. G09G 3/36

(52) U.S. Cl. CPC G09G 3/3614; G09G 3/3696; G09G 3/3618; G09G 2320/0247

(57) ABSTRACT

A driving circuit of a liquid crystal display device (100) is arranged to perform: a first polarity-inverting refresh operation during a first refresh period (B), of supplying, to only pixels in odd-numbered rows or even-numbered rows among the plurality of pixels, pixel voltages of opposite polarities to those of voltages which are retained in those pixels; a pause operation of not supplying a pixel voltage to any of the plurality of pixels during a pause period after the first refresh period, the pause period having a longer duration than that of any refresh period; and a second polarity-inverting refresh operation during a second refresh period (C) immediately after the pause operation, of supplying, to only pixels in the even-numbered rows or odd-numbered rows to which opposite-polarity pixel voltages were not supplied by the first polarity-inverting refresh operation, pixel voltages of opposite polarities to those of voltages which are retained in those pixels, where any refresh period is defined as a duration corresponding to a frame period which is determined in accordance with an input video signal.

### TECHNICAL FIELD

The present invention relates to a liquid crystal display device, and more particularly to a TFT liquid crystal display device of a lateral electric field mode.

### BACKGROUND ART

A TFT liquid crystal display device adjusts an amount of light which is transmitted through each pixel by controlling a voltage which is applied across the liquid crystal layer (which in electrical terms is referred to as a “liquid crystal capacitor”) in the pixel via a TFT, thereby performing displaying. The polarity of the voltage to be applied across the liquid crystal layer in each pixel is inverted every certain period. Such a method of driving a liquid crystal display device is called an AC driving method, which prevents a DC voltage from being applied to the liquid crystal layer for a long time. If a DC voltage were applied to the liquid crystal layer for a long time, ions in the liquid crystal material would become unevenly distributed (interfacial polarization), or the liquid crystal material might be deteriorated, thus lowering the display quality.

In the present specification, the voltage to be applied across the liquid crystal layer (liquid crystal capacitor) in each pixel will be referred to as a pixel voltage. The pixel voltage is a voltage to be applied between a pixel electrode of the pixel and the counter electrode, and is expressed as a potential of the pixel electrode relative to the potential of the counter electrode. When the potential of the pixel electrode is higher than the potential of the counter electrode, the pixel voltage is said to have a positive polarity; when the potential of the pixel electrode is lower than the potential of the counter electrode, the pixel voltage is said to have a negative polarity.

In a TFT liquid crystal display device, a pixel electrode is connected to the drain electrode of a TFT, such that a display signal voltage which is supplied from a source bus line that is connected to the source of the TFT is applied to the pixel electrode. The difference between the display signal voltage which is supplied to the pixel electrode and a counter voltage which is supplied to the counter electrode corresponds to the pixel voltage.

In a TFT liquid crystal display device, the pixel voltage polarity is inverted typically for every frame period. Herein, a frame period of a TFT liquid crystal display device is a period which is needed to supply pixel voltages to all pixels, i.e., a period from when a given gate bus line (scanning line) is selected and the next time that gate bus line is selected, which is also referred to as a vertical scanning period. The pixels are arranged in a matrix array of rows and columns where, typically, each gate bus line corresponds to a row of pixels and each source bus line corresponds to a column of pixels, such that pixel voltages are sequentially supplied in a row-by-row manner by scanning signals (gate signals) that are supplied to the gate bus lines.

Conventional, commonly-used TFT liquid crystal display devices have a frame period which is 1/60 of a second (i.e., a frame frequency of 60 Hz). In the case where the input video signal is e.g. an NTSC signal, which is a signal for interlace driving such that one frame (with a frame frequency of 30 Hz) is composed of the two fields (with a field frequency of 60 Hz) of an odd-numbered field and an even-numbered field, a TFT liquid crystal display device will supply pixel voltages to all pixels correspondingly to each field of the NTSC signal, and thus the TFT liquid crystal display device will have a frame period which is 1/60 of a second (with a frame frequency of 60 Hz). In recent years, in order to attain improved moving-picture displaying characteristics or 3D displaying, TFT liquid crystal display devices have been marketed which feature double-speed driving with a frame frequency of 120 Hz, or quad-speed driving with that of 240 Hz. Thus, a TFT liquid crystal display device includes a driving circuit which is arranged to determine a frame period (frame frequency) in accordance with an input video signal and supply pixel voltages to all pixels for each frame period.

In recent years, liquid crystal display devices of lateral electric field modes have been used more widely, e.g., the In Plane Switching (IPS) mode and the Fringe Field Switching (FFS) mode. As compared to liquid crystal display devices of vertical electric field modes such as the Vertical Alignment (VA) mode, liquid crystal display devices of a lateral electric field mode have a problem of noticeable flicker that is associated with polarity inversion of the pixel voltage. This is considered to be because, when the alignment of liquid crystal molecules in the liquid crystal layer undergoes a change that involves bend deformation or splay deformation, an orientation polarization is caused by asymmetry in the alignment of liquid crystal molecules.

For example, Patent Document 1 discloses a liquid crystal display device in which a pixel electrode is divided into first and second regions, such that the number of combteeth in the first region and the number of combteeth in the second region differ by one, while the number of combteeth formed in the pixel region and the number of slits between the combteeth are the same, whereby the flexoelectric effect is reduced.

Patent Document 2 discloses a liquid crystal display device which reduces the flexoelectric effect through control of electric field distribution, e.g., by disposing a dummy electrode in each region between two adjacent pixel electrodes, the dummy electrode being parallel to a plurality of band-like portions of the pixel electrode.

The applicant of the present application is manufacturing and selling a low-power consumption liquid crystal display device featuring TFTs in which an oxide semiconductor layer (e.g., a semiconductor layer of an In—Ga—Zn—O type) is used. A TFT including an In—Ga—Zn—O-type semiconductor layer has a high mobility (20 times or more of that of an a-Si TFT) and a low leakage current (less than 1/100 of that of an a-Si TFT). When a TFT having an In—Ga—Zn—O-type semiconductor layer is used as the pixel TFT, its small leakage current permits reduction in power consumption, by adopting pause driving (which may also be referred to as low-frequency driving).

A pause driving technique is described in Patent Document 3, for example. The entire disclosure of Patent Document 3 is incorporated herein by reference. Pause driving repeats the following cycle, in the usual 60 Hz driving (1 frame period= 1/60 of a second): after an image is written in 1 frame period ( 1/60 of a second), no image write is performed in the ensuing 59 frame periods ( 59/60 of a second). This pause driving may also be referred to as 1 Hz driving because an image is written only once per second. Herein, it is intended that pause driving means any driving method involving a pause period which is longer than a period of image writing, or any low-frequency driving with a frame frequency less than 60 Hz.

Likeliness of flicker perception depends on frequency. For example, changes in luminance which would not be annoying at 60 Hz may be prone to be perceived as flicker when the frequency is smaller than 60 Hz, especially 30 Hz or less. In particular, flicker is known to be very annoying when luminance changes occur with a frequency around 10 Hz.

### CITATION LIST

### Patent Literature

[Patent Document 1] Japanese Laid-Open Patent Publication No. 2010-2596

[Patent Document 2] Japanese Laid-Open Patent Publication No. 2011-169973

[Patent Document 3] International Publication No. 2013/008668

[Patent Document 4] International Publication No. 2013/073635

### SUMMARY OF INVENTION

### Technical Problem

The inventor has applied the aforementioned pause driving to a liquid crystal display device of a lateral electric field mode to find that a kind of flicker that is not addressed by the techniques described in Patent Documents 1 and 2 occurs.

The present invention aims to provide a TFT liquid crystal display device of a lateral electric field mode such that flicker is unlikely to be perceived even when driven with a frequency less than 60 Hz.

### Solution to Problem

A liquid crystal display device according to an embodiment of the present invention is a liquid crystal display device comprising: a display region having a plurality of pixels arranged in a matrix array of rows and columns, each pixel including first and second electrodes for generating a lateral electric field in a liquid crystal layer; and a driving circuit to supply a pixel voltage to each of the plurality of pixels, the driving circuit being arranged to perform: a first polarity-inverting refresh operation during a first refresh period, of supplying, to only pixels in odd-numbered rows or even-numbered rows among the plurality of pixels, or to only pixels in odd-numbered pairs or even-numbered pairs among a plurality of pairs each consisting of an odd-numbered row and an even-numbered row that are adjacent to one another among the plurality of pixels, pixel voltages of opposite polarities to those of voltages which are retained in those pixels; a pause operation of not supplying a pixel voltage to any of the plurality of pixels during a pause period after the first refresh period, the pause period having a longer duration than that of any refresh period; and a second polarity-inverting refresh operation during a second refresh period immediately after the pause operation, of supplying, to only pixels in the even-numbered rows or odd-numbered rows or the even-numbered pairs or odd-numbered pairs to which opposite-polarity pixel voltages were not supplied by the first polarity-inverting refresh operation, pixel voltages of opposite polarities to those of voltages which are retained in those pixels, where any refresh period is defined as a duration corresponding to a frame period which is determined in accordance with an input video signal.

In one embodiment, during the first refresh period, the voltages retained in the pixels in the even-numbered rows or odd-numbered rows or the even-numbered pairs or odd-numbered pairs to which opposite-polarity pixel voltages are not supplied by the first polarity-inverting refresh operation do not undergo polarity inversion.

In one embodiment, the driving circuit is arranged to, during the first refresh period, not supply pixel voltages to the pixels in the even-numbered rows or odd-numbered rows or the even-numbered pairs or odd-numbered pairs to which opposite-polarity pixel voltages are not supplied by the first polarity-inverting refresh operation.

In one embodiment, in the first refresh period, a period during which the opposite-polarity pixel voltages are supplied by the first polarity-inverting refresh operation is greater than ½ of the refresh period.

In one embodiment, the driving circuit is arranged to, during the first refresh period, again supply the opposite-polarity pixel voltages to only pixels in the odd-numbered rows or even-numbered rows or the odd-numbered pairs or even-numbered pairs to which the opposite-polarity pixel voltages were supplied by the first polarity-inverting refresh operation.

In one embodiment, in the first refresh period, a period during which the opposite-polarity pixel voltages are supplied by the first polarity-inverting refresh operation is ½ or less of the refresh period.

In one embodiment, a duration in which pixel voltages are respectively supplied to the plurality of pixels is equal to or greater than twice the pause period.

In one embodiment, the driving circuit is arranged to perform, during the first refresh period and in addition to the first polarity-inverting refresh operation, a first polarity-conserving refresh operation of supplying, to only pixels in the even-numbered rows or odd-numbered rows or the even-numbered pairs or odd-numbered pairs to which opposite-polarity pixel voltages were not supplied by the first polarity-inverting refresh operation, pixel voltages of same polarities as those of voltages which are retained in those pixels.

In one embodiment, a duration in which pixel voltages are respectively supplied to the plurality of pixels is equal to the pause period.

In one embodiment, the driving circuit is arranged to perform, during the first refresh period and in addition to the first polarity-inverting refresh operation, a second polarity-inverting refresh operation of supplying, to only pixels in the even-numbered rows or odd-numbered rows or the even-numbered pairs or odd-numbered pairs to which opposite-polarity pixel voltages were not supplied by the first polarity-inverting refresh operation, pixel voltages of opposite polarities to those of voltages which are retained in those pixels.

### Advantageous Effects of Invention

According to an embodiment of the present invention, there is provided a TFT liquid crystal display device of a lateral electric field mode such that flicker is unlikely to be perceived even when driven with a frequency less than 60 Hz.

### BRIEF DESCRIPTION OF DRAWINGS

FIG. 1 A diagram schematically showing the structure of a liquid crystal display device 100 according to an embodiment of the present invention, where (a) is a schematic plan view of the liquid crystal display device 100; and (b) is a schematic cross-sectional view taken along line 1B-1B′ in (a).

FIG. 2 (a) is a diagram showing an exemplary sequence of polarity inversions which is performed by a driving circuit of the liquid crystal display device 100; and (b) is a schematic diagram showing change in luminance over time.

FIG. 3 A diagram showing another exemplary sequence of polarity inversions which is performed by the driving circuit of the liquid crystal display device 100.

FIG. 4 A diagram showing still another exemplary sequence of polarity inversions which is performed by the driving circuit of the liquid crystal display device 100.

FIG. 5 (a) is a diagram showing still another exemplary sequence of polarity inversions which is performed by the driving circuit of the liquid crystal display device 100; and (b) is a schematic diagram showing change in luminance over time.

FIG. 6 A diagram showing an exemplary sequence of polarity inversions which is performed by the driving circuit of a liquid crystal display device according to another embodiment of the present invention.

FIG. 7 A diagram schematically showing the pixel structure of a liquid crystal display device 200 including a driving circuit which is arranged to perform polarity-inverting refresh operations by 2H inversion.

FIG. 8 A diagram showing luminance distribution within a pixel of an FFS mode liquid crystal display device, where (a) represents a luminance distribution under a pixel voltage of +2V; and (b) represents a luminance distribution under a pixel voltage of −2V.

FIG. 9 (a) is a diagram showing a sequence of polarity inversions according to a conventional AC driving method; and (b) is a schematic diagram showing change in luminance over time.

FIG. 10 A diagram showing results of measuring change in luminance over time in one pixel when an FFS mode liquid crystal display device is driven at 1 Hz, where (a) represents results in the absence of an applied offset voltage; and (b) represents results in the presence of an applied offset voltage.

### DESCRIPTION OF EMBODIMENTS

Hereinafter, with reference to the drawings, a liquid crystal display device according to an embodiment of the present invention and a driving method thereof will be described. Although an FFS mode liquid crystal display device will be illustrated below, embodiments of the present invention are not limited to the illustrated FFS mode liquid crystal display device; various known FFS mode liquid crystal display devices, or even IPS mode liquid crystal display devices are applicable.

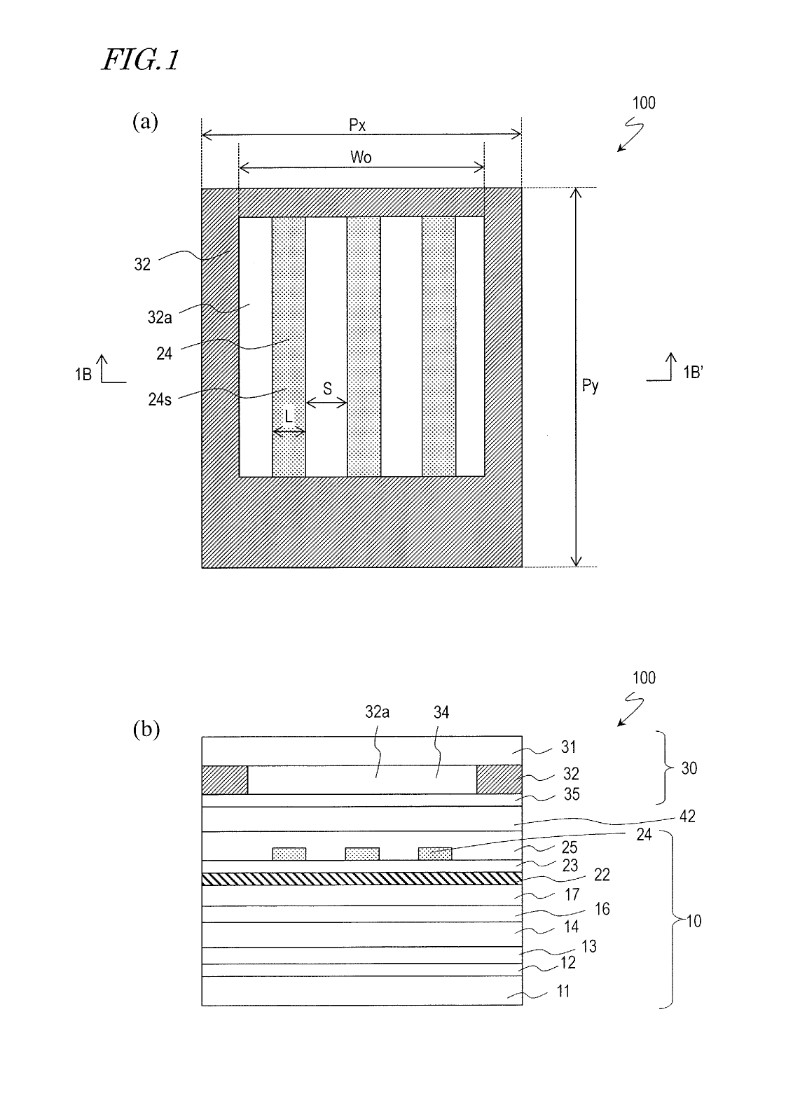

FIGS. 1(a) and (b) schematically show the structure of a liquid crystal display device 100 according to an embodiment of the present invention. The liquid crystal display device 100 is a TFT liquid crystal display device of the FFS mode. FIG. 1(a) is a schematic plan view of the liquid crystal display device 100, and FIG. 1(b) is a schematic cross-sectional view taken along line 1B-1B′ in FIG. 1(a). FIGS. 1(a) and (b) show structure corresponding to one pixel of the liquid crystal display device 100. The liquid crystal display device 100 includes a plurality of pixels arranged in a matrix array of rows and columns, such that the pixels are arranged with a pitch Px along the row direction and with a pitch Py along the column direction. The liquid crystal display device 100 includes a driving circuit not shown, the driving circuit being arranged to supply pixel voltages to the pixels, as will be described later. The driving circuit may be disposed in a peripheral region (frame region) of a display region that is constituted by the plurality of pixels, or may be separately provided.

The liquid crystal display device 100 includes a TFT substrate (first substrate) 10, a counter substrate (second substrate) 30, and a liquid crystal layer 42 provided between the TFT substrate 10 and the counter substrate 30. The liquid crystal display device 100 further includes a pair of polarizers not shown. The polarizers are disposed in crossed Nicols outside the TFT substrate 10 and the counter substrate 30. The transmission axis (polarization axis) of one is oriented in the horizontal direction, while the transmission axis of the other is oriented in the vertical direction.

In this order from the liquid crystal layer 42, the TFT substrate 10 includes a first alignment film 25, first electrodes 24, a dielectric layer 23, and a second electrode 22. Each first electrode 24 has a plurality of linear portions 24s which are parallel to one another. Although a structure in which each first electrode 24 has a plurality of linear portions 24s is illustrated, it may be the second electrode that includes a plurality of linear portions. The linear portions 24s can be formed by making slits in an electrically conductive film which composes the first electrodes 24, for example. One of the first electrodes 24 and the second electrode 22 may be pixel electrodes, and the other may be a counter electrode (common electrode); however, an example will be described herein where the first electrodes 24 are the pixel electrodes and the second electrode 22 is the counter electrode. In this example, the counter electrode is typically a spread electrode (i.e., a film electrode without slits or the like). The width L of each of the plurality of linear portions 24s of the pixel electrodes 24 may be e.g. not less than 1.5 μm and not more than 5 μm, and the width S of an interspace between two adjacent linear portions 24s may be e.g. greater than 2.0 μm but not more than 6.0 μm. The pixel electrodes 24 and the counter electrode 22 are made of a transparent electrically conductive material, e.g., ITO.

Each pixel electrode 24 is connected to a drain electrode of a TFT such that, via the TFT, a display signal voltage is supplied from a source bus line (not shown) that is connected to a source electrode of the TFT. The source bus lines are disposed so as to extend along the column direction, and the gate bus line are disposed so as to extend along the row direction. Preferable TFTs are those in which an oxide semiconductor is used. The oxide semiconductors to be suitably used for the liquid crystal display device 100 will be described later. Various FFS mode liquid crystal display devices are known to include TFTs in which an oxide semiconductor is used, as is disclosed in Patent Document 4, for example. The entire disclosure of Patent Document 4 is incorporated herein by reference. FIG. 1(b) schematically shows the layer structure in the case where bottom gate-type TFTs are adopted.

The TFT substrate 10 includes a substrate (e.g., a glass substrate) 11, a gate metal layer 12 formed thereon, a gate insulating layer 13 covering the gate metal layer 12, an oxide semiconductor layer 14 formed on the gate insulating layer 13, a source metal layer 16 formed on the oxide semiconductor layer 14, and an interlevel dielectric layer 17 formed on the source metal layer 16. Although the illustration is simplified herein, the gate metal layer 12 includes gate electrodes, gate bus lines, and lines for the counter electrode; the oxide semiconductor layer 14 includes active layers of the TFTs; and the source metal layer 16 includes source electrodes, drain electrodes, and source bus lines. The counter electrode 22 is formed on the interlevel dielectric layer 17. As necessary, a planarization layer may be further provided between the interlevel dielectric layer 17 and the counter electrode 22.

On the substrate (e.g., a glass substrate) 31, in this order from the liquid crystal layer 42, the counter substrate 30 includes a second alignment film 35 and a light shielding layer (black matrix) 32 having openings 32a (width Wo). A color filter layer 34 is formed in each opening 32a of the light shielding layer 32. The light shielding layer can be formed by using a black resin layer having photosensitivity, for example. The color filter layer 34 can also be formed by using a colored resin layer having photosensitivity. On the outside (i.e., the opposite side from the liquid crystal layer 42) of the substrate 31, as necessary, a transparent electrically conductive layer (not shown) made of ITO or the like may be provided in order to prevent electrification.

The liquid crystal layer contains a nematic liquid crystal material having a positive dielectric anisotropy, and the liquid crystal molecules contained in the liquid crystal material are aligned essentially horizontally by the first alignment film 25 and the second alignment film 35. The alignment directions as regulated by the first alignment film and the second alignment film 35 may be parallel or antiparallel. The directions of alignment as regulated by the first alignment film 25 and the second alignment film 35 are essentially parallel to the direction in which the linear portions 24s extend. A pretilt angle that is defined by the first alignment film 25 and the second alignment film 35 is 0′, for example.

Now, with reference to FIG. 8 to FIG. 10, a problem arising when the FFS mode liquid crystal display device 100 is subjected to AC driving by a conventional method will be described.

FIG. 8 is a diagram showing luminance distribution within a pixel, where FIG. 8(a) represents a luminance distribution under a pixel voltage of +2V, and FIG. 8(b) represents a luminance distribution under a pixel voltage of −2V. The pixel voltage is the voltage of a pixel electrode 24 based on the potential of the counter electrode 22.

As will be clear from a comparison between the pixel luminance distribution images of FIG. 8(a) and FIG. 8(b), it is brighter when a positive pixel voltage is applied than when a negative pixel voltage is applied. The pixel shown herein is images obtained through microscopic observation of a pixel of a prototyped liquid crystal display panel, which had the construction shown in FIG. 1, and more specifically the following construction.

Px=27 μm, Py=81 μm, Wo=19 μm, L/S=2.6 μm/3.8 μm

P type liquid crystal material: ΔE=7.8, Δ∈=0.103; white-displaying voltage of 4.6V; liquid crystal layer thickness of 3.4 μm

As can be seen from FIG. 8(a), when a positive pixel voltage is applied, there is high luminance between slits of the pixel electrode 24, and low luminance in the linear portions 24s of the pixel electrode 24. On the other hand, when a negative pixel voltage is applied, as can be seen from FIG. 8(b), there is high luminance in the linear portions 24s of the pixel electrode 24, and low luminance between slits of the pixel electrode 24. This is due to a difference in the alignment of liquid crystal molecules.

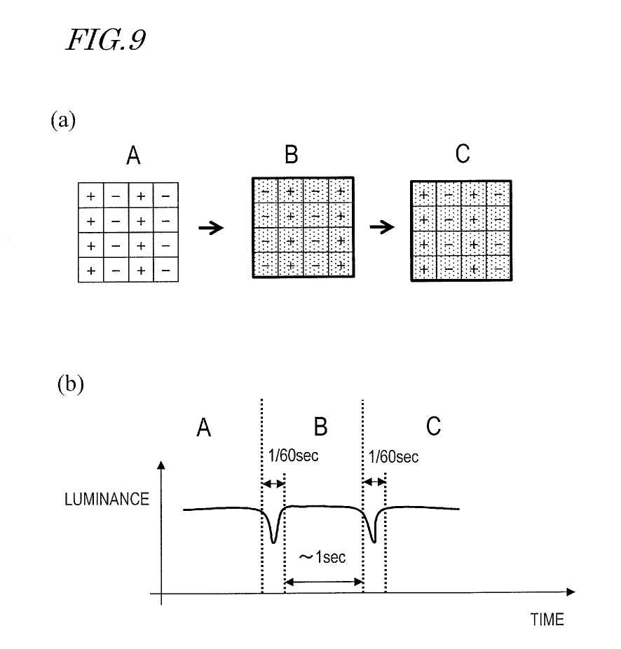

Thus, when a pixel whose luminance changes with the pixel voltage polarity is subjected to AC driving, changes in luminance as caused by the changing polarity are likely to be perceived as flicker. FIG. 9 shows a sequence of polarity inversions according to a conventional AC driving method. Shown herein is an example of source-line inversion driving. That is, in a given frame A shown in FIG. 9(a), the pixels in the left most column all have positive polarity (+) and the pixels in the next column all have negative polarity (−), the pixel voltage polarities being arranged so as to alternate from column to column. In a next frame B, the pixel voltage polarities of all pixels are inverted (frame inversion). Furthermore, in a next frame C, too, the pixel voltage polarities of all pixels are inverted, thus reverting to the same polarity distribution as in frame A. Herein, the frame period may be 1/60 of a second, for example.

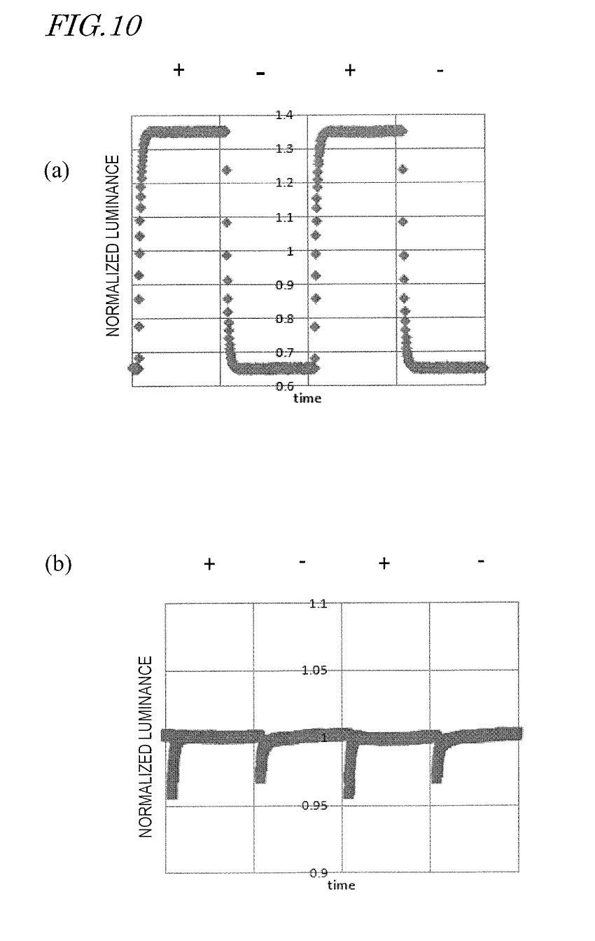

When this liquid crystal display device is subjected to the aforementioned 1 Hz driving (where the following cycle is repeated: after an image is written in 1 frame period ( 1/60 of a second), no image write is performed in the ensuing 59 frame periods ( 59/60 of a second)), as shown in FIG. 9(b), luminance change will appear in response to frame inversion. Such transient changes in luminance are found to be a new problem that cannot be solved by the techniques described in Patent Documents 1 and 2. This will be described with reference to FIG. 10.

FIG. 10 is a diagram showing results of measuring luminance over time in one pixel when subjected to 1 Hz driving, where FIG. 10(a) represents results in the absence of an applied offset voltage, and FIG. 10(b) represents results in the presence of an applied offset voltage. An offset voltage is a DC voltage which is applied also in generic liquid crystal display devices to prevent flicker, mainly to prevent the pixel voltage from taking different absolute values between the positive polarity and the negative polarity owing to the feed-through voltage of a TFT.

As shown in FIG. 10(a), when no offset voltage is applied, the luminance significantly differs between when the pixel voltage is of positive polarity and when it is of negative polarity, as has been described with reference to FIG. 9. On the other hand, under an applied offset voltage, as shown in FIG. 10(b), there is hardly any difference in luminance between the positive polarity and the negative polarity, but the luminance drops upon each inversion of the pixel electrode polarity. This drop in luminance cannot be solved by any conventional techniques, including the techniques described in Patent Documents 1 and 2. The liquid crystal display device according to an embodiment of the present invention includes a driving circuit which is able to perform a driving method that solves this problem. The fundamental construction of a driving circuit is well known, and the description thereof will be omitted. As the driving circuit which performs the driving method described below, the driving circuit described in Patent Document 3 can be used.

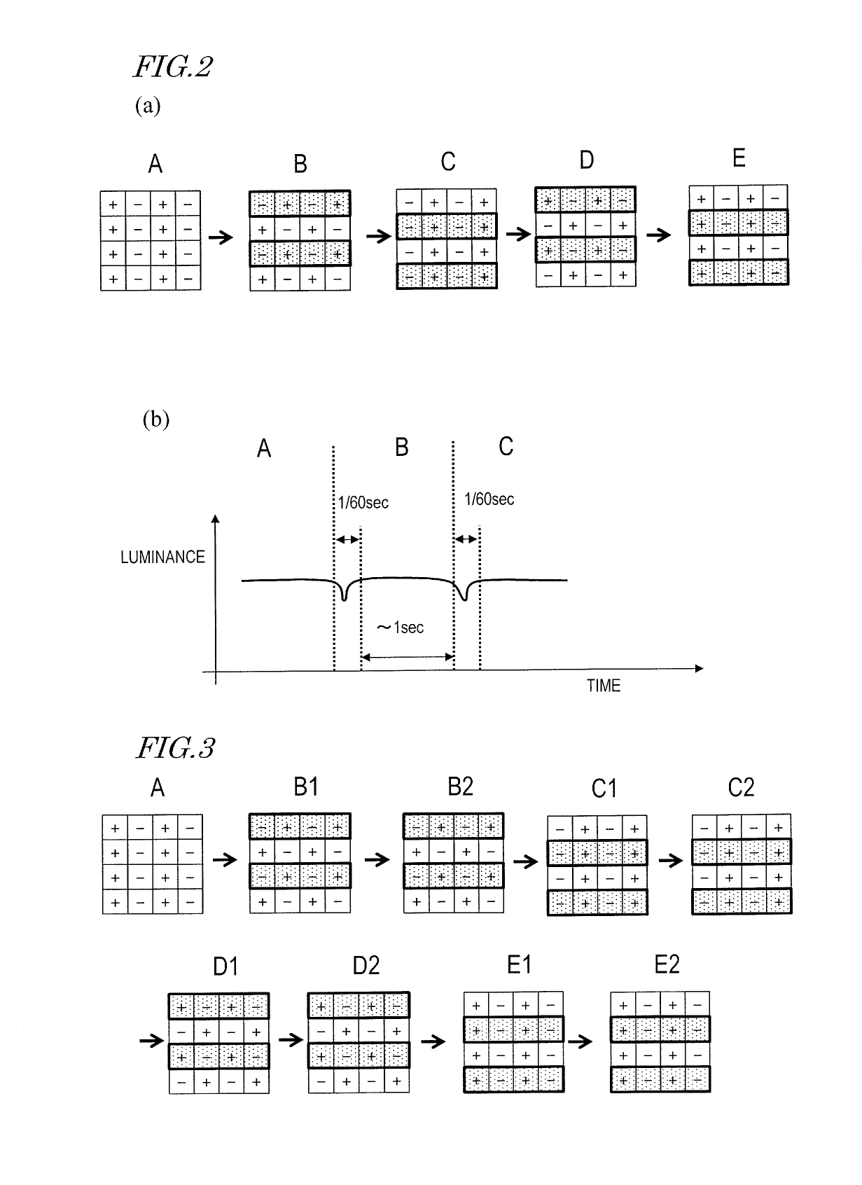

Next, with reference to FIG. 2 to FIG. 5, an operation under the driving method which is performed by the driving circuit included in the liquid crystal display device according to an embodiment of the present invention will be described. In FIG. 2 to FIG. 5, the pixels to undergo polarity inversion are surrounded by bold lines, and the pixels to which pixel voltages are to be applied are shown hatched.

The driving circuit included in the liquid crystal display device 100 according to an embodiment of the present invention is arranged to perform: a first polarity-inverting refresh operation during a first refresh period, of supplying, to only pixels in odd-numbered rows or even-numbered rows among the plurality of pixels, pixel voltages of opposite polarities to those of voltages which are retained in those pixels; a pause operation of not supplying a pixel voltage to any of the plurality of pixels during a pause period after the first refresh period, the pause period having a longer duration than that of any refresh period; and a second polarity-inverting refresh operation during a second refresh period immediately after the pause operation, of supplying, to only pixels in the even-numbered rows or odd-numbered rows to which opposite-polarity pixel voltages were not supplied by the first polarity-inverting refresh operation, pixel voltages of opposite polarities to those of voltages which are retained in those pixels, where any refresh period is defined as a duration corresponding to a frame period which is determined in accordance with an input video signal. The first polarity-inverting refresh operation and the second polarity-inverting refresh operation both effect polarity inversion in a row-by-row manner. Such polarity inversion may be referred to as “1H inversion”. The driving methods shown in FIG. 2 to FIG. 5 all satisfy this requirement.

In the embodiments shown in FIG. 2 to FIG. 4, during the first refresh period, the voltages retained in the pixels in the even-numbered rows or odd-numbered rows to which opposite-polarity pixel voltages are not supplied by the first polarity-inverting refresh operation do not undergo polarity inversion. This provides an advantage of, in the first polarity-inverting refresh operation, being able to supply pixel voltages to pixels for a longer time than conventionally.

First, with reference to FIG. 2(a), an exemplary driving method of performing polarity-inverting refresh operations by 1H inversion will be described. FIG. 2(a) is a diagram showing an exemplary sequence of polarity inversions which is performed by the driving circuit of the liquid crystal display device 100 according to an embodiment of the present invention.

As shown in FIG. 2(a), in a given frame A, the pixel voltage polarities are arranged so as to alternate from column to column (which may be referred to as a column inverted state or a source bus line inverted state).

During a first refresh period corresponding to a next frame B, only to pixels in the odd-numbered rows (or even-numbered rows) among the plurality of pixels, a first polarity-inverting refresh operation of supplying pixel voltages of opposite polarities to those of voltages which are retained in those pixels is performed, and pixel voltages are not supplied to pixels in the even-numbered rows (or odd-numbered rows) to which opposite-polarity pixel voltages are not supplied by the first polarity-inverting refresh operation. Therefore, in the first refresh period, it is ensured that the period during which opposite-polarity pixel voltages are supplied by the first polarity-inverting refresh operation is greater than ½ of the refresh period, whereby the pixels can be sufficiently charged. Note that, the polarity distribution of frame B is in a so-called dot inverted (1H dot inverted) state, where adjacent pixels have opposite pixel voltage polarities along both of the column direction and the row direction.

After frame B, during a pause period having a longer duration (which herein is 59/60 frames) than that of any refresh period (frame period), a pause operation of not supplying a pixel voltage to any of the plurality of pixels is performed.

Next, during a second refresh period corresponding to a frame C following immediately after the pause operation, a second polarity-inverting refresh operation is performed to supply, to only pixels in the even-numbered rows (or odd-numbered rows) to which opposite-polarity pixel voltages were not supplied by the first polarity-inverting refresh operation, pixel voltages of opposite polarities to those of voltages which are retained in those pixels. At this time, similarly to the above, pixel voltages are not supplied to pixels in the odd-numbered rows (or even-numbered rows) to which opposite-polarity pixel voltages are not supplied by the second polarity-inverting refresh operation. The polarity distribution of frame C is in a column inverted state, with its positive/negative being opposite to those in frame A.

Thereafter, after a pause operation is performed, the aforementioned operation is repeated by swapping the odd-numbered rows and the even-numbered rows (frames D and E), thus reverting to the same polarity distribution as in frame A. Frame D is in a dot inverted state (“1H dot inverted” being abbreviated as “dot inverted”), positive/negative of this polarity distribution being opposite to those in frame B. Frame E has the same polarity distribution as that of frame A.

Thus, the polarity distribution according to the driving method illustrated in FIG. 2(a) alternately undergoes a column inverted state and a dot inverted state from refresh period to refresh period. Although FIG. 2(a) illustrates a case where polarity changes are effected in the order of frame A→B→C→D→E(=A) from frame A being in a column inverted state, this is not a limitation; for example, beginning from frame D in a dot inverted state, polarity changes may be effected in the order of frame D→C→B→A→(=E).

By adopting this driving method, as shown in FIG. 2(b), the drop in luminance upon polarity inversions can be made about one half of that in the case where the conventional driving method shown in FIG. 9(b) is adopted. As a result, flicker is unlikely to be perceived even when driven with a frequency less than 60 Hz.

Alternatively, the driving circuit may be arranged to perform a sequence of polarity inversions as shown in FIG. 3.

In the sequence shown in FIG. 2(a), only one polarity-inverting refresh operation is conducted during one refresh period (frame period). On the other hand, in the sequence shown in FIG. 3, during the first refresh period, opposite-polarity pixel voltages are again supplied, only to pixels in the odd-numbered rows (or even-numbered rows) to which opposite-polarity pixel voltages were supplied by the first polarity-inverting refresh operation. The same is also true of the second refresh period. That is, frame B is divided into two subframes B1 ( 1/120 of a second) and B2 ( 1/120 of a second), and the same opposite-polarity pixel voltages are supplied during a period corresponding to each subframe. In doing this, each period of supplying opposite-polarity pixel voltages is ½ or less of a refresh period. As is well known, a pixel in a TFT liquid crystal display device may not arrive at the desired voltage with a single application of a pixel voltage. Of course, it would be possible to perform overshoot driving; however, as is illustrated in FIG. 3, it would also be possible to apply a pixel voltage twice successively in an attempt to arrive at the desired voltage. The same is also true of frame C and subsequent frames.

In the sequence shown in FIG. 2 and FIG. 3, pixel voltages are supplied only to the pixels which undergo polarity inversion; therefore, the duration in which pixel voltages are respectively supplied to the plurality of pixels is equal to or greater than twice the pause period. In other words, each pixel needs to retain a pixel voltage over a longer time (twice or more) than conventionally. Depending on the TFT characteristics, the voltages retained by the pixels may lower.

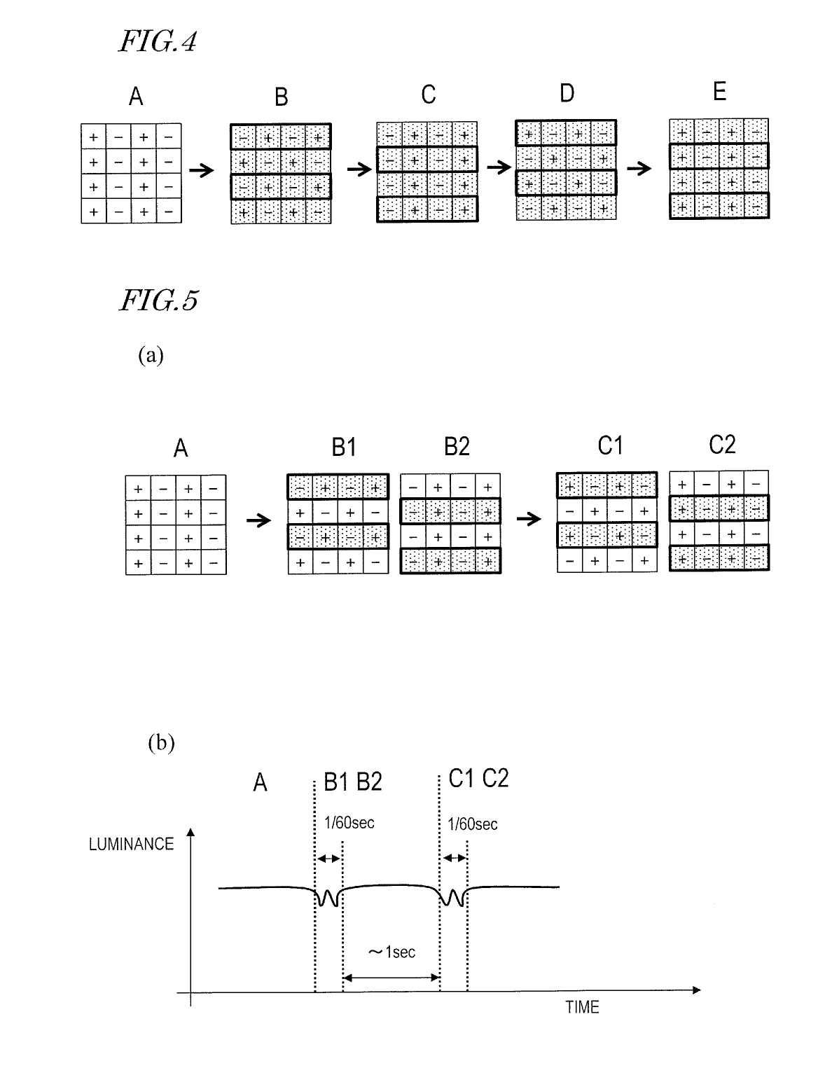

In such cases, the driving circuit may be arranged to perform a sequence of polarity inversions as shown in FIG. 4. That is, in the sequence shown in FIG. 4, during the first refresh period, a first polarity-conserving refresh operation is performed additionally to the first polarity-inverting refresh operation to supply, to only pixels in the even-numbered rows (or odd-numbered rows) to which opposite-polarity pixel voltages were not supplied by the first polarity-inverting refresh operation, pixel voltages of the same polarities as those of voltages which are retained in those pixels. Therefore, when the sequence of FIG. 4 is adopted, pixel voltages are supplied to all pixels during each refresh period, so that the duration in which pixel voltages are respectively supplied to the plurality of pixels is equal to the pause period.

Furthermore, the driving circuit may be arranged to perform a sequence of polarity inversions as shown in FIG. 5.

In the sequence shown in FIG. 5, during the first refresh period, a second polarity-inverting refresh operation is performed additionally to the first polarity-inverting refresh operation to supply, to only pixels in the even-numbered rows (or odd-numbered rows) to which opposite-polarity pixel voltages were not supplied by the first polarity-inverting refresh operation, pixel voltages of opposite polarities to those of voltages which are retained in those pixels. That is, frame B is divided into two subframes B1 ( 1/120 of a second) and B2 ( 1/120 of a second), and the first polarity-inverting refresh operation is performed during a period corresponding to subframe B1, and the second polarity-inverting refresh operation is performed during a period corresponding to subframe B2. Subframe C is also similarly divided into subframes C1 and C2.

When this driving method is adopted, as shown in FIG. 5(b), two drops in luminance will occur upon polarity inversions; however, each drop in luminance is made into about a half of that in the case of adopting the conventional driving method shown in FIG. 9(b). Therefore, flicker is unlikely to be perceived even when driven with a frequency less than 60 Hz.

The liquid crystal display device according to the above embodiment includes a driving circuit which is arranged to perform polarity-inverting refresh operations (1H inversion) during the first refresh period and the second refresh period, of supplying, to only pixels in the odd-numbered rows or even-numbered rows, pixel voltages of opposite polarities to those of voltages which are retained in those pixels. However, without being limited thereto, the liquid crystal display device according to an embodiment of the present invention may include a driving circuit which is arranged to perform a polarity-inverting refresh operation (2H inversion) during a first refresh period, of supplying, to only pixels in odd-numbered pairs or even-numbered pairs among a plurality of pairs each consisting of an odd-numbered row and an even-numbered row that are adjacent to one another, pixel voltages of opposite polarities to those of voltages which are retained in those pixels.

Specifically, such a driving circuit is arranged to perform: a first polarity-inverting refresh operation during a first refresh period, of supplying, to only pixels in odd-numbered pairs or even-numbered pairs among a plurality of pairs each consisting of an odd-numbered row and an even-numbered row that are adjacent to one another among the plurality of pixels, pixel voltages of opposite polarities to those of voltages which are retained in those pixels; a pause operation of not supplying a pixel voltage to any of the plurality of pixels during a pause period after the first refresh period, the pause period having a longer duration than that of any refresh period; and a second polarity-inverting refresh operation during a second refresh period immediately after the pause operation, of supplying, to only pixels in the even-numbered pairs or odd-numbered pairs to which opposite-polarity pixel voltages were not supplied by the first polarity-inverting refresh operation, pixel voltages of opposite polarities to those of voltages which are retained in those pixels. The first polarity-inverting refresh operation and the second polarity-inverting refresh operation may be referred to as “2H inversion”, because they are each performed with respect to every two rows.

With reference to FIG. 6, an exemplary driving method of performing polarity-inverting refresh operations by 2H inversion will be described. FIG. 6 is a diagram showing an exemplary sequence of polarity inversions which is performed by the driving circuit arranged to perform polarity-inverting refresh operations by 2H inversion, as corresponding to FIG. 2(a), which is a case of performing polarity-inverting refresh operations by 1H inversion. However, the polarity distribution of frame A herein is in a 2H dot inverted state.

As shown in FIG. 6, in a given frame A, the pixel voltage polarity is arranged so as to alternate for every two rows (2H dot inverted state).

During a first refresh period corresponding to a next frame B, only to pixels in odd-numbered pairs (or even-numbered pairs) among a plurality of pairs each consisting of an odd-numbered row and an even-numbered row that are adjacent to one another among the plurality of pixels, a first polarity-inverting refresh operation of supplying pixel voltages of opposite polarities to those of voltages which are retained in those pixels is performed, and pixel voltages are not supplied to pixels in the even-numbered pairs (or odd-numbered pairs) to which opposite-polarity pixel voltages are not supplied by the first polarity-inverting refresh operation. Therefore, in the first refresh period, it is ensured that the period during which opposite-polarity pixel voltages are supplied by the first polarity-inverting refresh operation is greater than ½ of the refresh period, whereby the pixels can be sufficiently charged. Note that, in the polarity distribution of frame B, the pixel voltage polarities are arranged so as to alternate from column to column (a column inverted state or a source bus line inverted state).

After frame B, during a pause period having a longer duration (which herein is 59/60 frames) than that of any refresh period (frame period), a pause operation of not supplying a pixel voltage to any of the plurality of pixels is performed.

Next, during a second refresh period corresponding to a frame C following immediately after the pause operation, a second polarity-inverting refresh operation is performed to supply, to only pixels in the even-numbered pairs (or odd-numbered pairs) to which opposite-polarity pixel voltages were not supplied by the first polarity-inverting refresh operation, pixel voltages of opposite polarities to those of voltages which are retained in those pixels. At this time, similarly to the above, pixel voltages are not supplied to pixels in the odd-numbered pairs (or even-numbered pairs) to which opposite-polarity pixel voltages are not supplied by the second polarity-inverting refresh operation. The polarity distribution of frame C is in a 2H dot inverted state, with its positive/negative being opposite to those in frame A.

Thereafter, after a pause operation is performed, the aforementioned operation is repeated while swapping the odd-numbered pairs and the even-numbered pairs (frames D and E), thus reverting to the same polarity distribution as in frame A. Frame D is in a column inverted state, positive/negative of this polarity distribution being opposite to those in frame B. Frame E has the same polarity distribution as that of frame A.

Thus, the polarity distribution according to the driving method illustrated in FIG. 6 alternately undergoes a 2H dot inverted state and a column inverted state from refresh period to refresh period. Although FIG. 6 illustrates a case where polarity changes are effected in the order of frame A→B→C→D→E(=A) from frame A being in a 2H dot inverted state, this is not a limitation; for example, beginning from frame D in a column inverted state, polarity changes may be effected in the order of frame D→C→B→A→(=E).

Thus, even when polarity-inverting refresh operations are performed by 2H inversion, an effect is attained in that flicker is unlikely to be perceived even when driven with a frequency less than 60 Hz, similarly to the case of performing polarity-inverting refresh operations by 1H inversion. The same is also true of the other exemplary polarity inversion sequences illustrated in FIG. 3, FIG. 4, and FIG. 5(a).

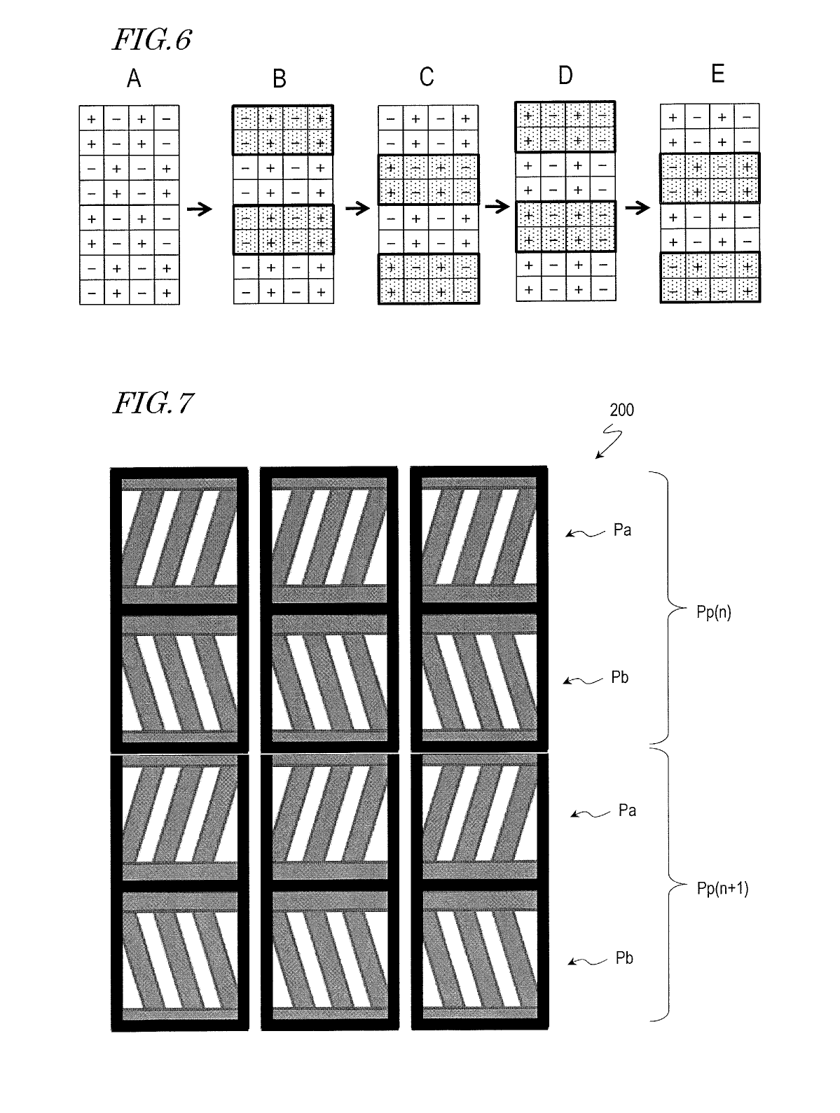

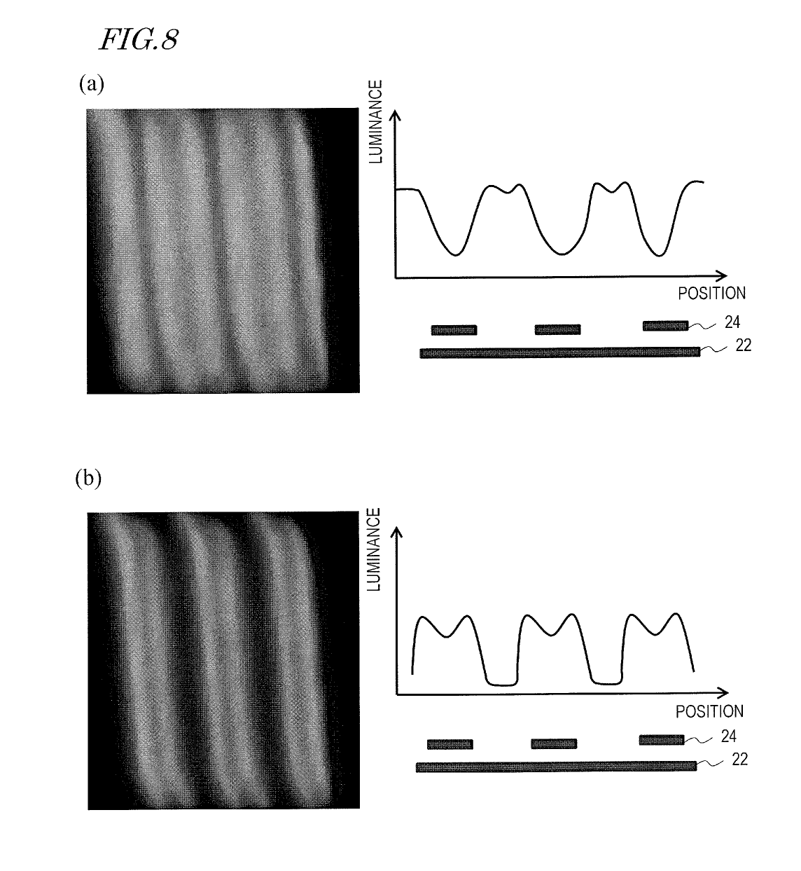

FIG. 7 schematically shows the pixel structure of a liquid crystal display device 200 including a driving circuit which is arranged to perform polarity-inverting refresh operations by 2H inversion. The driving circuit of the liquid crystal display device 200 is able to perform the sequence of polarity inversions shown in FIG. 6.

The liquid crystal display device 200 is an FFS mode liquid crystal display device having a pseudo dual-domain structure, such that the plurality of pixels of the liquid crystal display device 200 include two kinds of pixels Pa and Pb which are of different electrode structures. As is illustrated herein for example, the pixels Pa and the pixels Pb differ in terms of the direction that the linear portions (or slits) of the pixel electrode extend. When voltages are applied to the pixels Pa and pixels Pb, the liquid crystal molecules rotate in respectively different directions, whereby two kinds of liquid crystal domains are created whose directors cross each other. Since these two kinds of liquid crystal domains mutually compensate for each other's retardation, color washouts associated with the viewing angle can be suppressed. While a structure in which two kinds of liquid crystal domains are created within a single pixel is called a dual-domain structure, a structure in which two adjacent pixels constitute two kinds of liquid crystal domains is called a pseudo dual-domain structure. A pseudo dual-domain structure is suitably used in a high-resolution liquid crystal display device for mobile devices that feature small pixels. An FFS mode liquid crystal display device having a pseudo dual-domain structure is disclosed in Japanese Laid-Open Patent Publication No. 2009-237414, for example. Moreover, Japanese Laid-Open Patent Publication No. 2000-29072 discloses an IPS mode liquid crystal display device having pseudo dual domains. The entire disclosure of Japanese Laid-Open Patent Publication No. 2009-237414 and Japanese Laid-Open Patent Publication No. 2000-29072 is incorporated herein by reference.

In the liquid crystal display device 200, pixel rows consisting only of pixels Pa and their adjacent pixel rows consisting only of pixels Pb alternate in the column direction. Deeming each odd-numbered row and each even-numbered row that are adjacent to one another as a pair (Pp), then the plurality of pixels consist of odd-numbered pairs (e.g., Pp(n)) and even-numbered pairs (e.g., Pp(n+1)), where the odd-numbered pairs and the even-numbered pairs alternate in the column direction. Now, n is a positive integer. For example, assuming n=1 in FIG. 7, a pair Pp(1) is composed of pixels Pa in the first row and pixels Pb in the second row; and a pair Pp(2) is composed of pixels Pa in the third row and pixels Pb in the fourth row. Similarly, a pair Pp(3) is composed of pixels Pa in the fifth row and pixels Pb in the sixth row; and a pair Pp(4) is composed of pixels Pa in the seventh row and pixels Pb in the eighth row.

Therefore, the driving method which performs polarity-inverting refresh operations by 1H inversion described with reference to FIG. 2 to FIG. 5 can be altered into a driving method which performs polarity-inverting refresh operations by 2H inversion, by replacing each row (1H) with a respective pair (pair of pixel rows: 2H).

For example, replacing each row in frame D of FIG. 2(a) with a respective pair of pixel rows results in frame A(=E) of FIG. 6; replacing each row in frame C of FIG. 2(a) with a respective pair of pixel rows results in frame B of FIG. 6; replacing each row in frame B in FIG. 2(a) with a respective pair of pixel rows results in frame C of FIG. 6; and replacing each row in frame A(=E) of FIG. 2(a) with a respective pair of pixel rows results in frame D of FIG. 6.

As will be clear from what has been described above, a liquid crystal display device according to an embodiment of the present invention may be arranged to perform polarity-inverting refresh operations by 1H inversion or 2H inversion.

In the illustrated FFS mode liquid crystal display device of a pseudo dual-domain structure or in an IPS mode liquid crystal display device, two kinds of pixels of respectively different electrode structures are disposed in adjacent relationship along the column direction. Different electrode structures might result in different optimum counter voltages. Therefore, by performing polarity inversions for every rows containing two kinds of pixels, it is possible to effectively suppress flicker due to deviations in counter voltage that are caused by the differences in pixel structure.

Although 1 Hz is illustrated as an example of pause driving, the pause driving to be performed by a liquid crystal display device according to an embodiment of the present invention is not limited thereto. The pause period may be any period longer than the frame period, and the aforementioned effect can be obtained in pause driving with any frame frequency less than 60 Hz. Moreover, while an outstanding flexoelectric effect will be obtained in an FFS mode liquid crystal display device in which a nematic liquid crystal material with positive dielectric anisotropy is used, flicker can be made less likely to be perceived also in an FFS mode liquid crystal display device in which a nematic liquid crystal material with negative dielectric anisotropy is used.

It will be appreciated that a liquid crystal display device according to an embodiment of the present invention is able to perform usual driving (with a frame frequency of 60 Hz), in addition to the above-described pause driving. Although the frame frequency in usual driving may be greater than 60 Hz, a greater frame frequency will result in increased power consumption, which is not preferable.

As described above, TFTs including an oxide semiconductor layer are preferably used as the TFTs of the liquid crystal display device 100 according to an embodiment of the present invention. As the oxide semiconductor, semiconductors of In—Ga—Zn—O types (hereinafter abbreviated as “In—Ga—Zn—O-type semiconductors”) are preferable, and In—Ga—Zn—O-type semiconductors containing a crystalline portion are further preferable. Herein, an In—Ga—Zn—O-type semiconductor is a ternary oxide of In (indium), Ga (gallium), and Zn (zinc); and the ratio of In, Ga, and Zn (composition ratio) is not particularly limited, including, for example, In:Ga:Zn=2:2:1, In:Ga:Zn=1:1:1, In:Ga:Zn=1:1:2, and so on.

A TFT including an In—Ga—Zn—O-type semiconductor layer has a high mobility (20 times or more of that of an a-Si TFT) and a low leakage current (less than 1/100 of that of an a-Si TFT), and therefore is suitably used not only as a pixel TFT but also as a driving TFT. By using TFTs including an In—Ga—Zn—O-type semiconductor layer, it is possible to increase the effective aperture ratio of a display device and also reduce the power consumption of the display device.

The In—Ga—Zn—O-type semiconductor may be amorphous, or contain a crystalline portion. As crystalline In—Ga—Zn—O-type semiconductors, crystalline In—Ga—Zn—O-type semiconductors whose c axis is oriented substantially perpendicular to the layer plane are preferable. The crystal structure of such an In—Ga—Zn—O-type semiconductor is disclosed in Japanese Laid-Open Patent Publication No. 2012-134475, for example. The entire disclosure of Japanese Laid-Open Patent Publication No. 2012-134475 is incorporated herein by reference.

Instead of an In—Ga—Zn—O-type semiconductor, the oxide semiconductor layer may contain any other oxide semiconductor. For example, it may contain a Zn—O-type semiconductor (ZnO), an In—Zn—O-type semiconductor (IZO (registered trademark)), a Zn—Ti—O-type semiconductor (ZTO), Cd—Ge—O-type semiconductor, a Cd—Pb—O-type semiconductor, CdO (cadmium oxide), an Mg—Zn—O-type semiconductor, an In—Sn—Zn—O-type semiconductor (e.g., In₂O₃—SnO₂—ZnO), an In—Ga—Sn—O-type semiconductor, or the like.

### INDUSTRIAL APPLICABILITY

The present invention is broadly applicable to TFT liquid crystal display devices of lateral electric field modes.

### REFERENCE SIGNS LIST

10 TFT substrate (first substrate)
11 substrate
12 gate metal layer
13 gate insulating layer
14 oxide semiconductor layer
16 source metal layer
17 interlevel dielectric layer
22 counter electrode (second electrode)
23 dielectric layer
24 pixel electrode (first electrode)
24s linear portion
25 first alignment film
30 counter substrate (second substrate)
31 substrate
32 light shielding layer
32a opening
34 color filter layer
35 second alignment film
42 liquid crystal layer
100 liquid crystal display device

1. A liquid crystal display device comprising:
a display region having a plurality of pixels arranged in a matrix array of rows and columns, each pixel including first and second electrodes for generating a lateral electric field in a liquid crystal layer; and
a driving circuit to supply a pixel voltage to each of the plurality of pixels,
the driving circuit being arranged to perform:
a first polarity-inverting refresh operation during a first refresh period, of supplying, to only pixels in odd-numbered rows or even-numbered rows among the plurality of pixels, or to only pixels in odd-numbered pairs or even-numbered pairs among a plurality of pairs each consisting of an odd-numbered row and an even-numbered row that are adjacent to one another among the plurality of pixels, pixel voltages of opposite polarities to those of voltages which are retained in those pixels;
a pause operation of not supplying a pixel voltage to any of the plurality of pixels during a pause period after the first refresh period, the pause period having a longer duration than that of any refresh period; and
a second polarity-inverting refresh operation during a second refresh period immediately after the pause operation, of supplying, to only pixels in the even-numbered rows or odd-numbered rows or the even-numbered pairs or odd-numbered pairs to which opposite-polarity pixel voltages were not supplied by the first polarity-inverting refresh operation, pixel voltages of opposite polarities to those of voltages which are retained in those pixels,
where any refresh period is defined as a duration corresponding to a frame period which is determined in accordance with an input video signal.

2. The liquid crystal display device of claim 1, wherein, during the first refresh period, the voltages retained in the pixels in the even-numbered rows or odd-numbered rows or the even-numbered pairs or odd-numbered pairs to which opposite-polarity pixel voltages are not supplied by the first polarity-inverting refresh operation do not undergo polarity inversion.

3. The liquid crystal display device of claim 1, wherein the driving circuit is arranged to, during the first refresh period, not supply pixel voltages to the pixels in the even-numbered rows or odd-numbered rows or the even-numbered pairs or odd-numbered pairs to which opposite-polarity pixel voltages are not supplied by the first polarity-inverting refresh operation.

4. The liquid crystal display device of claim 1, wherein, in the first refresh period, a period during which the opposite-polarity pixel voltages are supplied by the first polarity-inverting refresh operation is greater than ½ of the refresh period.

5. The liquid crystal display device of claim 1, wherein the driving circuit is arranged to, during the first refresh period, again supply the opposite-polarity pixel voltages to only pixels in the odd-numbered rows or even-numbered rows or the odd-numbered pairs or even-numbered pairs to which the opposite-polarity pixel voltages were supplied by the first polarity-inverting refresh operation.

6. The liquid crystal display device of claim 5, wherein, in the first refresh period, a period during which the opposite-polarity pixel voltages are supplied by the first polarity-inverting refresh operation is ½ or less of the refresh period.

7. The liquid crystal display device of claim 1, wherein a duration in which pixel voltages are respectively supplied to the plurality of pixels is equal to or greater than twice the pause period.

8. The liquid crystal display device of claim 1, wherein the driving circuit is arranged to perform, during the first refresh period and in addition to the first polarity-inverting refresh operation, a first polarity-conserving refresh operation of supplying, to only pixels in the even-numbered rows or odd-numbered rows or the even-numbered pairs or odd-numbered pairs to which opposite-polarity pixel voltages were not supplied by the first polarity-inverting refresh operation, pixel voltages of same polarities as those of voltages which are retained in those pixels.

9. The liquid crystal display device of claim 8, wherein a duration in which pixel voltages are respectively supplied to the plurality of pixels is equal to the pause period.

10. The liquid crystal display device of claim 1, wherein the driving circuit is arranged to perform, during the first refresh period and in addition to the first polarity-inverting refresh operation, a second polarity-inverting refresh operation of supplying, to only pixels in the even-numbered rows or odd-numbered rows or the even-numbered pairs or odd-numbered pairs to which opposite-polarity pixel voltages were not supplied by the first polarity-inverting refresh operation, pixel voltages of opposite polarities to those of voltages which are retained in those pixels.
